(19) United States
(12) Patent Application Publication
(10) Pub. No.: US 2024/0364068 A1
(43) Pub. Date: Oct. 31, 2024

(54) METHODS AND SYSTEMS FOR STABILIZATION OF WAVELENGTH-SELECTIVE OPTICAL ELEMENTS DURING TRANSIENT LASER OPERATIONS

(71) Applicant: Lawrence Livermore National Security, LLC, Livermore, CA (US)

(72) Inventors: Robert J. Deri, Pleasanton, CA (US); Paul A. Rosso, Livermore, CA (US); Benjamin J. Haid, Oakland, CA (US); Michael Runkel, Livermore, CA (US); James Eugene Fair, Nevada City, CA (US)

(21) Appl. No.: 18/647,270

(22) Filed: Apr. 26, 2024

Related U.S. Application Data
(60) Provisional application No. 63/498,764, filed on Apr. 27, 2023.

(51) Int. Cl. H01S 3/04

(52) U.S. Cl. CPC H01S 3/0401; H01S 3/0404; H01S 3/0405

(57) ABSTRACT

Methods, devices and systems are described that enable maintaining the temperature of an optical component at a target temperature despite transient fluctuations in the laser beam that illuminates the component. One example method includes preheating the optical component to a target temperature value by applying an external heat source to the optical component. The optical component has an initial thermal resistance and heat sink temperature while being preheated. Next, the laser is turned on, and the external heat source is removed or reduced, while changing one or both the thermal resistance or heat sink temperature from their initial values to lower values to maintain a temperature of the optical component at the target temperature value while the laser source is illuminating the optical component.

### CROSS-REFERENCE TO RELATED APPLICATIONS

This application claims priority to the provisional application with Ser. No. 63/498,764, titled “METHOD FOR STABILIZATION OF WAVELENGTH-SELECTIVE OPTICAL ELEMENTS DURING TRANSIENT LASER OPERATIONS,” filed Apr. 27, 2023. The entire contents of the above noted provisional application are incorporated by reference as part of the disclosure of this document.

### STATEMENT REGARDING FEDERALLY SPONSORED RESEARCH OR DEVELOPMENT

This invention was made with Government support under Contract No. DE-AC52-07NA27344 awarded by the United States Department of Energy. The Government has certain rights in the invention.

### TECHNICAL FIELD

The disclosed technology generally relates to optical systems and components that operate using lasers.

### BACKGROUND

Maintaining stable laser spectral and pointing characteristics is important for laser systems, including all high-power lasers to avoid damaging downstream optics or the laser itself by exposure to high power optical beams. Optical elements that exhibit wavelength- or angular-selective properties due to diffraction or optical interference effects are often used to stabilize, point, combine or demultiplex optical beams. Such optical elements include diffraction gratings (including holographic, Bragg, and ruled gratings) and optical thin film filters. The use of such elements to control laser systems, including both conventional lasers and semiconductor laser diodes, are well known. However, as these approaches are extended to higher power laser beams, issues arise due to the heating of the optical elements due to their residual optical absorption, especially during laser system transients associated with ramping the optical power from a cold start, or rapidly changing the output power. This residual absorption heats the optical element, which causes its spectral and pointing characteristics to change due to thermal expansion and thermal changes in refractive index, which then causes the selectivity of the optical element to change as the laser power is varied.

It is therefore highly desirable to develop techniques that allow the temperature of optical components to remain stable during exposure to laser illumination.

### SUMMARY

Among other features and benefits, the disclosed embodiments can be used in optical systems, including high power laser systems that use large aperture optics to stabilize or tune the laser output wavelength, deflect (change the pointing of) the laser output, or combine (“wavelength multiplex”) the outputs of multiple lasers into a single beam. The disclosed techniques allow the laser to rapidly reach operation at its full capability after turn-on, or as its power is changed.

### BRIEF DESCRIPTION OF THE DRAWINGS

FIG. 1 illustrates simulated transient thermal response of an example optical component in accordance with an example embodiment.

FIG. 2 illustrates an example hardware schematic for implementing time-varying heating and thermal resistance mechanisms in accordance with an example embodiment.

FIG. 3 illustrates a configuration of an optical component with an associated channel to allow the flow of cooling and heating gases in accordance with an example embodiment.

FIG. 4 illustrates a set of example performance plots for the geometry that was illustrated in FIG. 3 in accordance with an example embodiment.

FIG. 5 illustrates another set of example performance plots for geometry of FIG. 3 that incorporates a continuously varying cooling gas flow rate in accordance with an example embodiment.

FIG. 6 illustrates a set of operations that can be carried out to maintain a stable temperature for an optical component in an optical system in accordance with an example embodiment.

### DETAILED DESCRIPTION

As noted earlier, wavelength-selective optical elements such as filters and gratings are frequently used to tune, stabilize and/or multiplex the outputs of lasers. During laser system transients, such as ramping the optical power from a cold start, the residual optical absorption in such elements can cause shifts in their spectral characteristics. For example, their transmitted wavelength may change due to thermally induced changes in the optical element's refractive index or dimensions. Robustness to such transients is important for various applications, such as for increasing process throughput by allowing the optical system to quickly achieve and maintain the desired operating characteristics.

While such transients can in principle be mitigated by aggressive heat sinking (e.g., using very low thermal resistance and/or very cold heat sinks), this approach is not always practical; this is especially the case for transmissive optics with large optical apertures because their overall thermal resistance tends to be quite large. The disclosed embodiments aim to minimize or eliminate such transient spectral shifts in optical components and can be applied to both transmissive and reflective optics.

Since the temperature change of the optical component(s) depend on the heat load (absorbed optical power) as well as the thermal resistance and the heat sink temperature of the optical component, the optical component's selectivity can in principle be stabilized by aggressive thermal management that provide a low thermal resistance or low heat sink temperature, as noted above. This is not always practical, however, due to spatial and geometric constraints. As laser power increases, the clear aperture of the optical component must increase so that it will not be damaged by the laser power. For transmissive optics, the optical component can only be conduction cooled through its edges, which provides a high thermal resistance and an undesirable temperature gradient across the optical component. This has led to the use of convective gas cooling, in which cold gas flows across the transmissive faces of the optical component are used for cooling. In this case, the heat sink temperature is the temperature of the free gas stream far from the optic being cooled. To provide very low thermal resistance, this approach requires high velocity flows of high pressure gas, and requires bulky gas blowers that consume significant electrical power.

Compact laser systems with constrained power requirements can use gas cooling technology to obtain a sufficiently low thermal resistance to mitigate steady-state temperature rises, but cannot achieve the low thermal resistance to mitigate transients for optical components with moderate absorption. For example, a gas flow rate of a few liters per minute can provide a heat transfer coefficient of approximately 5 W/m²−K. An optical component with 10 ppm optical absorption, operating under an illumination of 2 kW/cm², would exhibit a 40° C. temperature rise with this thermal resistance. This corresponds to a wavelength change of 0.4 nm at 1000 nm operating wavelength, which is unacceptable for many applications requiring precision wavelength control. Such offsets can be compensated in the steady-state by manufacturing optics with a built-in wavelength offset, so that they exhibit the correct performance under the desired operating conditions. However, the correct performance will only be achieved when the optical component is at its steady-state operating temperature, and will deviate during transients in the optical power. The response time of the optical component to such transients can be quite long. For this example thermal resistance, a typical 3 mm thick glass optical component with heat capacity of 4000 J/m²−K would exhibit a very long 1/e thermal response time of approximately 860 seconds.

Alternative methods for improving transient stability minimize the overall heat flux on the optical component by either fabricating optical elements with lower absorption, or operating them with lower optical irradiance (W/cm²). In practice, however, optical components often exhibit nonzero absorption, and high-power laser designs trend towards higher irradiance to achieve more compact designs that consume less electrical power in order to achieve greater electro-optic efficiency. In some cases, optical components are deliberately manufactured from materials with higher absorption in order to obtain significant advantages in manufacturability, as is the case with holographically-defined gratings in photothermally refractive glass. Finally, it is often desirable for the optical components to exhibit some degree of thermal variability, so that temperature tuning can be used to offset steady-state wavelength or pointing deviations due to manufacturing imperfections or variations in operating power.

The disclosed embodiments address the above issue, and describe methods, devices and systems that minimize or reduce transient variations in the wavelength-and/or pointing-behavior of an optical component, without requiring very low thermal resistance that is difficult to achieve, a very low optical absorption, or unacceptably low operating irradiance.

The disclosed technology can be implemented in various embodiments to achieve temperature stability of an optical component during transient variations in the optical power to which it is exposed. These and other features and benefits can be achieved at least in-part by using a combination of a time-varying heat source and time-varying thermal resistance and/or heat sink temperature to minimize or reduce transient variations in the wavelength-behavior and/or pointing-behavior of the optical component.

In some embodiments, to maintain a desired temperature, T₀, of the optical component at all times and independent of the optical exposure level of the optical component, the disclosed embodiments employ an external heat source, and reduce heating from this external source in addition to reduced thermal resistance and/or heat sink temperature to compensate for changes in the optical exposure of the optical component. This compensation approach does not require a feedback loop; the temporal profiles of the heat source and thermal resistance can be determined in advance of a transient, provided the optical exposure variation is known in advance.

To illustrate the disclosed methodology, we consider the case of an optical component which is initially exposed to an optical beam that abruptly turns on from zero power to a fixed power, P, at a time defined as t=0. At a time, t, long after t=0, the optical component will reach its steady state temperature, T₀, which will be determined by its absorption, αL, and thermal resistance, R, to a thermal sink, Tₛ:

$${T}_{0} = {T}_{S} ( t >> 0 ) + R ( t >> 0 ) α L P \qquad ( 1 )$$

In Equation (1), R(t>>0) and Tₛ(t>>0) represent the resistance and heat sink temperature a long time after the transient. This equation is only valid in the steady state; rapid adjustments in R and/or Tₛ cannot maintain the optical component at a constant temperature in response to the change in exposure, P, due the finite heat capacity C of the optical component, which creates a thermal response time, RC. In some embodiments, the thermal transient is mitigated by exposing the optical component to a heat source, Q, at a time well before t=0. Then, the optical component's temperatures before (T(<0)) and long after (T(t>>0)) the optical exposure change are:

$$\begin{matrix}T ( t < 0 ) = {T}_{S} ( t < 0 ) + R ( t < 0 ) Q , & ( 2 ) \\ {T}_{0} ( t >> 0 ) = {T}_{0} = {T}_{S} ( t >> 0 ) + R ( t >> 0 ) α L P & ( 3 )\end{matrix}$$

For simplicity and purposes of illustration only, we assume the heat sink temperature is held constant at all time Tₛ(t<0)=Tₛ(t>>0)=Tₛ, although this is not meant to limit the scope of the disclosed embodiments that can readily accommodate variations in Tₛ. In the illustrative example, the required heating of the optical component to maintain T(t<0)=T₀ is:

$$Q = \{ R ( t >> 0 ) / R ( t < 0 ) \} α L P \qquad ( 4 )$$

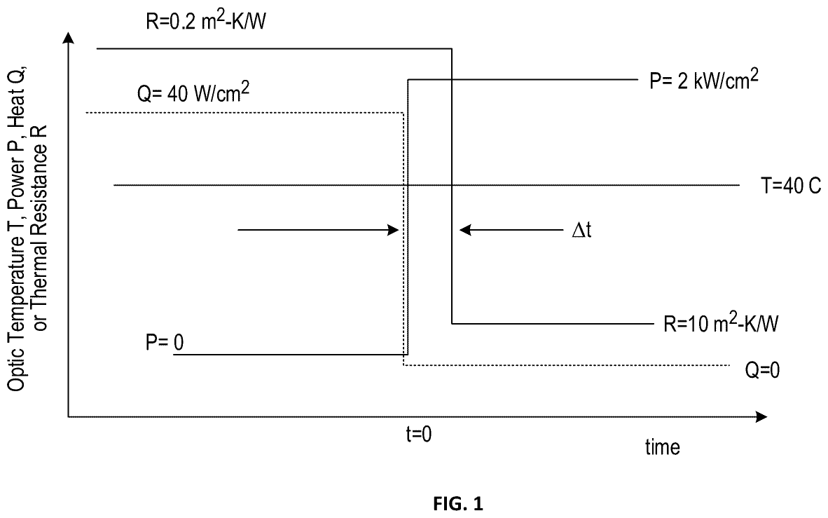

To minimize the power consumption required to heat the optical component prior to optical power turn-on at t=0, the optical component's thermal resistance R(t<0) is increased well beyond the steady-state value R(t>>0). Thermal simulations show that the temporal variation of R(t) and Q(t) need not be carefully controlled to maintain the temperature of the optical component near the target value, T₀, for a moderate time duration after power turn-on. In one embodiment, a simple step function response in external heat and thermal resistance is sufficient to achieve a near-constant optical component temperature. Example responses are shown in FIG. 1, which illustrates the simulated transient thermal response of an optical component with 10 ppm optical absorption and 4000 J/m²−K heat capacity. Specifically, prior to ramping up (or turning on) the laser power, P, the external heat (Q=40 W/cm²) and resistivity (R=0.2 m²−K/W) are at a higher level to maintain the component's temperature at a desired value (T=40). When the laser is turned on (P=2 k W/cm² at t=0), the external heat is discontinued (Q=0), while the resistivity is lowered (R=10 m²−K/W), which allows the component's temperature to remain at the desired value (T=40).

For an ideal system with no additional heat capacitance in the system, the optical component's temperature will remain perfectly stable over time if the time delay, Δt, between the step in heat, Q, and the step in thermal resistance, R, is zero. In practical systems, a nonzero time delay, Δt, may be required to minimize the temporal variation in optical component temperature.

In some embodiments, it is desirable to minimize the required heat load, Q, on the optical component before turn-on to minimize power consumption, although this is not a requirement for all embodiments or applications of the disclosed technology. If the heat sink temperature is held constant, as assumed in FIG. 1, this means that the thermal resistance prior to turn on needs to be large. In practice, this approach can be limited by heat leaks from the optical component that will prevent the achievement of arbitrarily large thermal resistance. For this reason, in some embodiments, both the thermal resistance and heat sink temperature are varied. In the case of a step function change in heat sink temperature, the required heat load is:

$$Q = \{ {T}_{S} ( t >> 0 ) - {T}_{S} ( t < 0 ) \} / R ( t < 0 ) + \{ R ( t >> 0 ) / R ( t < 0 ) \} α L P \qquad ( 5 )$$

This equation shows that a decrease in heat sink temperature after turn-on can enable an arbitrarily low heat load, Q, in the case of heat leak limits on the maximum thermal resistance.

In some embodiments, it is desirable to reduce the external heat Q to zero at long times after turn-on to minimize power consumption, although this is not a requirement for all embodiments or applications of the disclosed technology. It is clear that the same approach as shown in FIG. 1 can compensate power exposures that begin from a non-zero optical exposure at time t<0 by reducing the step changes in thermal resistance and heat. It is also clear that the same approach can compensate rapid changes in power reduction (from high optical power at time t<0 to lower optical power at time t>0), by reversing the direction of change in the external heat and thermal resistance.

In some applications, due to practical implementation limitations, the above-described method can result in some temporal variation of the optical component temperature due to additional physical effects. These include nonzero switching speeds for the external heat, optical power, thermal resistance, and heat sink temperature. They also include physical effects such as cooling gas transit times, scattered optical power that heats optical mounts, and the temperature-dependent thermophysical properties (heat capacity, thermal conductivity) of hardware used to implement thermal resistance paths and heat sinks. In some embodiments, to compensate these effects, timing of the heat source and thermal resistance changes relative to the power turn-on (e.g., Δt in FIG. 1) can be adjusted to minimize the optical component's temperature variation. In addition, in some embodiments, a slow temporal variation in thermal resistance after turn-on can be used to maintain a constant optical component temperature for arbitrarily long times after turn-on.

Various embodiments of the disclosed technology may employ different techniques and components for providing the time-dependent heat source Q. These include any one or any combination of the following options for the heat source:
Resistive heating elements placed around the perimeter of the optical component, outside its clear aperture.
Optical heating by illumination with a low intensity secondary optical source, that is absorbed by the optical component. This includes sources such as infrared lamps, LEDs, or laser diodes, and the like.
Optical heating by illumination with the same laser used for high power operations but operating at much lower power than after turn-on.
Convective heating from a flow of heated gas across the optical component.

The use of heated gas flows can be advantageous in some applications compared to other techniques because (i) using resistive elements in proximity to the optical component may be subject to optically-induced damage from scattered high power beams, (ii) geometric constraints may prevent exposure to additional optical sources, and the electro-optic inefficiency of such sources tends to increase the required power consumption, and (iii) the primary laser source may be constrained to be completely off before turn-on, for example to maintain eye-safe conditions in the laser bay.

Various embodiments of the disclosed technology may employ different techniques and components for providing the time-dependent thermal pathway to effectuate a time-varying thermal resistance, R. These include any one or any combination of the following options:
Convective cooling with a constant coolant gas flow operating with time-varying temperature.
Conduction cooling of the optical component using a time-varying thermal resistance to a constant temperature heat sink, adjusted, for example, by adjusting mechanical contact, contact pressure, or gas pressure.
Conduction cooling of the optical component using a fixed thermal resistance to a heat sink with time-varying temperature.
Convective cooling of the optical component by a flow of cool gas across the optical component, with time-varying flow rate and constant gas temperature.

The use of convective cooling with variable flow rate can be advantageous in some applications compared to other techniques because (i) conduction cooling typically introduces thermal gradients along the aperture of a transmissive optical component, that increase with the optic aperture, whereas gas cooling creates minimal transients; (ii) gas flow rates can be changed very quickly compared to changing gas temperature.

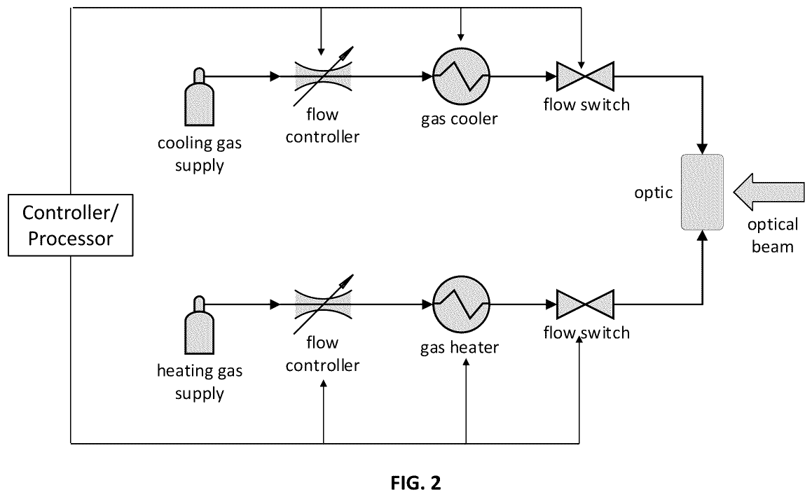

In one embodiment, convective heating is used for the external heat source, and convective cooling is used for the time-variable thermal resistance. To optimize performance, different gas temperatures can be used for the heating and thermal resistance (cooling) flows. To maximize transient stability of the optical component, this embodiment uses separate gas streams for the heating and cooling functions. This avoids the need to dynamically vary the temperature of the gas streams. The flow rates of both streams can be controlled rapidly and in a stepwise manner by switching them on or off using valves. FIG. 2 illustrates an example hardware schematic for this embodiment that includes, in the cooling path, a cooling gas supply, a flow controller, a gas cooler and a flow switch, and, in the heating path, a heating gas supply, a flow controller, a gas heater and a flow switch. The two paths are operated at different times. One or more controllers or processors may also be included to control the operations of the flow controllers, gas heater/cooler and/or the flow switches regulate the gas flows and to selectively turn the gas flows on or off.

In another embodiment, a continuously varying flow rate of the cooling gas after turn-on is used. This flow variation provides a continuously variable thermal resistance after turn-on and is achieved by dynamically adjusting the flow rate with the mass flow controller in the cooling gas flow path shown in FIG. 2. This configuration enables additional adjustment of the thermal resistance on long timescales, to maintain temperature stability of the optic for an indefinite period.

In some embodiments, flow rates of the cold gas result in a gas velocity of 1 meter/second or greater near the optical component. This minimizes transients due to gas transit time effects and reduces the thermal resistance after turn-on. Higher flow rates also improve the temperature uniformity across the optical component. To minimize the mass flow rate required to achieve such velocities, it is preferred that the gas flow be channeled between the wavelength-selective optical component and a transparent optical barrier, with a channel width of a few millimeters.

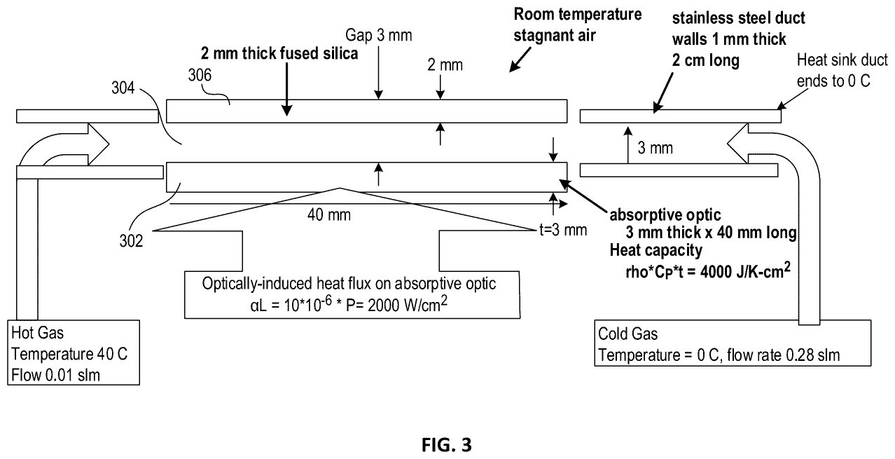

FIG. 3 illustrates an example configuration of an optical component with an associated channel to allow the flow of cooling and heating gases. FIG. 3 shows a cross-sectional view of the optical component 302, a glass component 306 (e.g., fused silica with no, or negligible absorption and/or wavelength selectivity—a 2-mm thick fused silica in the depicted example) that is separated from the optical component 302 by an air gap 304, forming a channel to allow hot or cold gasses to pass therethrough. The primary laser beam is incident from the bottom on the optical component 302, which in this example is a 3-mm thick by 40-mm long absorptive optical element with a heat capacity (ρCₚt) of 4000 J/K-cm². Other features such as implementation details of external heat leakage through the silica channel confinement optic and extra heat capacity associated with the gas delivery ducts are also illustrated. In some embodiments, the gas stream can flow in two channels, one on the top and one on bottom of the optical component, to further reduce thermal resistance. In addition, a nozzle can be used where the gas is introduced into the cooling channel, to further increase gas velocity. It is recognized that some operational or geometric constraints may prohibit operating the optical component at such gas velocities; in this case, the optical component's temperature stability can still be improved using lower gas velocities.

In some embodiments, a gas composition that maximizes heat transfer is utilized. Pure helium gas is preferred if only thermal management is considered. However, a helium/oxygen gas mixture may be preferred for certain optical components that require a partial pressure of oxygen to improve the robustness of optical coatings to high optical power.

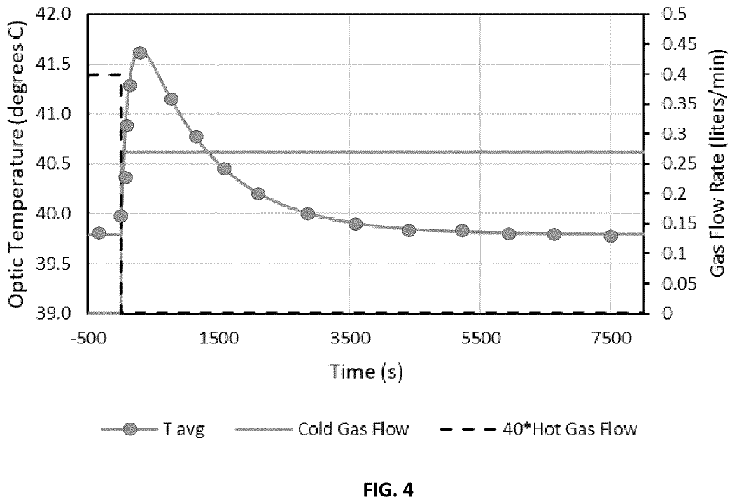

Simulated performance for a model system with representative non-idealities is illustrated in FIG. 4 for the geometry that was illustrated in FIG. 3, which shows the optical component's temperature response to a power turn-on at time=0 for the conditions described below, with step-function changes in gas flow rates. The hot gas flow rate (dashed black line) is scaled by a factor 40× for visibility on the plot. This example uses the same parameters as the example of FIG. 1, but includes fluid dynamics, external thermal resistances and the heat capacity of the gas delivery ducts. In this simulation, the gas is dry air at atmospheric pressure. It flows within a channel between the optical component to be cooled and a silica window, the sole purpose of which is to provide a transparent barrier to define the gas flow. Steel ducts are used to deliver gases into the channel, and gas exits from the channel through gaps between the steel delivery ducts and the silica and optical component. Prior to turn-on, hot gas at 55.5° C. temperature is flowing from one stainless duct at a rate of 0.01 liters per minute. These conditions maintain the optical component's temperature at 40° C. prior to turn-on. This hot gas flow terminates at turn on, and a cold gas flow at 0° C. temperature begins at turn-on, with a fixed flow rate of 0.28 liters minute. The flow rates reported in FIG. 4 correspond to a square optical component, with an area of 40×40 mm². This corresponds to an average cold gas flow velocity of 0.03 meters/second in the channel.

At turn-on, the optical power on the optical component increases from 0 to 2,000 W/cm², of which 10 ppm is absorbed in the optical component. FIG. 4 shows that the average temperature of the optical component varies by about 1.6° C. and stabilizes over a time interval of approximately 4000 seconds after turn-on, when only step-function changes in the gas flows are implemented. This temperature deviation is significantly less than the 40° C. rise that would occur in the absence of the initial hot gas preheating.

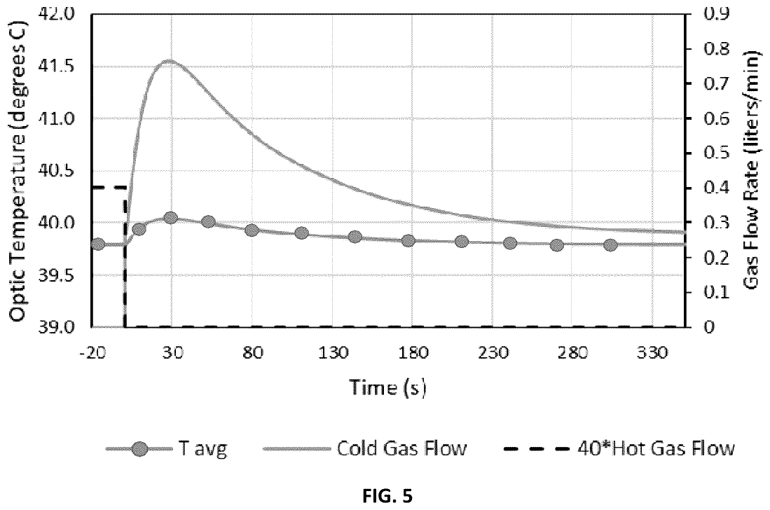

FIG. 5 shows that the temperature variation can be reduced to less than 0.25 degrees Celsius by continuously varying the flow rate of the cooling gas after turn-on. The figure illustrates that the temporal profile of the cold gas flow rate is not a step function but rather increases continuously after turn-on with a first (finite) rise time, reaching approximately 0.75 liters per minute, and is reduced gradually with a finite fall time to ultimately reach about 0.3 liters per minute. Flow rates reported in FIG. 5 correspond to a square optical component. The example in FIG. 5 illustrates that a temperature stability range of less than 2° C. is achievable. Real-time temporal adjustment can be achieved in practice using a feedback loop to minimize the optic temperature variation, using a feedback signal obtained by monitoring the optic temperature and/or wavelength. For wavelength-locked systems, this is most readily achieved by monitoring the emission wavelength of the locked laser. For other applications, the feedback can also be obtained by monitoring the optical component's temperature, for example with an infrared thermal sensor.

The disclosed embodiments can be implemented for various applications where maintaining a stable temperature of optical components are important. Examples include optical systems that use high-power lasers for medical applications including proton therapy and generation of isotopes, for industrial applications such as cutting and laser peening, scientific research including in particle colliders that utilize lasers, and others. The disclosed techniques, while described using example optical components that operate in transmission, can also be implemented on reflective optical components. For example, in the configuration of FIG. 3, the primary optical laser would illuminate the fused silica and the optical component from the top, and the optical component would have a reflective bottom surface (e.g., a reflective coating). The optical components disclosed herein that can benefit from temperature-stabilized operation include, but are not limited to, lenses, mirror, prisms, polarizers, beamsplitters, wave plates, optical flats and other components.

The disclosed embodiments can be used in optical systems that use continuous wave and/or pulsed laser sources. In the case of the latter, the operations are most effective when either (i) the laser pulse duration is longer than the desired temperature settling time of the optical component or (ii) the laser is repetitively pulsed with a time interval between pulses that is much shorter than the desired temperature settling time of the optic. In both these pulsed laser cases, the settling time can be appropriately tuned or selected as described herein. The disclosed technology is particularly beneficial for providing temperature stabilization for systems that utilize high power lasers; for example, those that emit an optical beam with average power of approximately 1 kW or more.

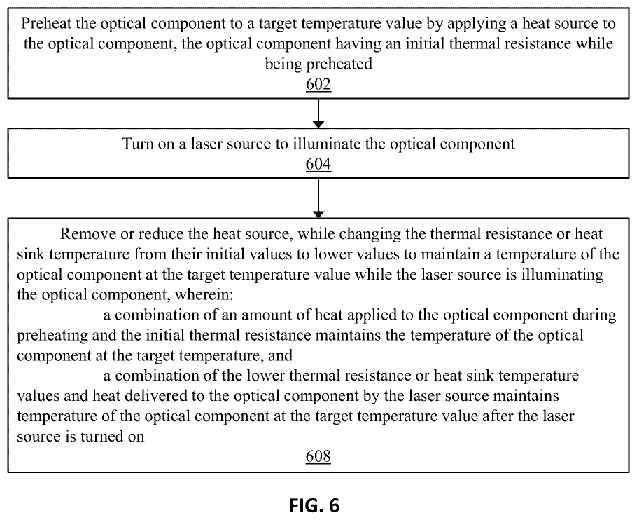

FIG. 6 illustrates a set of operations that can be carried out to maintain a stable temperature of an optical component in an optical system in accordance with an example embodiment. At 602, the optical component is preheated to a target temperature value by applying an external heat source to the optical component; the optical component has an initial thermal resistance and heat sink temperature while being preheated. At 604, a laser source is turned on to illuminate the optical component. At 606, the external heat source is reduced or removed, while changing the thermal resistance and/or heat sink temperature from their initial values to lower values to maintain a temperature of the optical component at the target temperature value while the laser source is illuminating the optical component. In this method, a combination of an amount of heat applied to the optical component during preheating and the initial thermal resistance maintains the temperature of the optical component at the target temperature, and a combination of the lower thermal resistance and/or heat sink temperature values and heat delivered to the optical component by the laser source maintains temperature of the optical component at the target temperature value after the laser source is turned on.

In one example embodiment, the heat source is turned off simultaneously with turning on the laser, and changing the thermal resistance to a lower value includes cooling the optical component. In another example embodiment, pre-heating the optical component is performed by convective heating and changing the thermal resistance to the lower value is performed by convective cooling. In yet another example embodiment, pre-heating the optical component includes applying a heated gas flow to a surface of the optical component, and changing the thermal resistance to the lower value includes applying a cooled gas flow to the surface of the optical component. In still another example embodiment, one or both of the heated gas flow or the cooled gas flow includes air, oxygen or helium.

According to another example embodiment, removing or reducing the heat source consists of removing the heat source that is done simultaneously with turning on the laser source, and changing the thermal resistance to the lower value is done after a predetermined delay subsequent to turning on the laser source. In one example embodiment, the predetermined delay is determined to minimize temporal variations in the optical component's temperature. In another example embodiment, removing or reducing the heat source consists of removing the heat source that is done simultaneously with turning on the laser source, and changing the thermal resistance to the lower value is initiated simultaneously with turning on the laser source by turning on a cooled air gas flow across a surface of the optical component.

In another example embodiment, removing or reducing the heat source consists of removing the heat source that is done simultaneously with turning on the laser source, and changing the thermal resistance to the lower value is initiated simultaneously with turning on the laser source by continuously increasing a cooled air gas flow across a surface of the optical component before continuously decreasing the cooled air gas flow across the surface of the optical component. In still another example embodiment, a heat load associated with preheating the optical component is determined based at least on an absorption value of the optical component, and a power of the laser source illumination. In yet another example embodiment, the heat load associated with preheating the optical component is determined based additionally on a thermal sink temperature before turning on the laser and at steady-state. In one example embodiment, the above noted method further includes increasing the thermal resistance value and heat applied to the optical component accompanied by a reduction in a laser beam that illuminates the optical component to maintain the temperature of the optical component at the target temperature.

Another aspect of the disclosed embodiments relates to an optical system with improved temperature stability that includes an optical component configured to receive illumination from a laser source, where the optical component has a particular absorption coefficient at an operating wavelength of the laser source. The optical system also includes a flow channel formed between a first surface of the optical component and a transparent optical element, wherein the transparent optical element has substantially no absorption in the operating wavelength of the laser source. The flow channel is configured to receive a heated gas flow or a cooled gas flow therein for heating or cooling the optical component, respectively.

In one example embodiment, the optical system includes one or more flow controllers, a gas cooler, a gas heater and one or more flow switches to receive one or more gases for producing the heated gas flow or the cooled gas flow. In another example embodiment, the optical component is configured to operate in transmission, with the illumination entering through a second surface of the optical component opposite to the first surface and exiting the first surface. In yet another example embodiment, the optical component is configured to operate in reflection, with the illumination reaching the first surface after passing through the transparent optical element and the flow channel, and reflecting from the optical component before passing again through the flow channel and the transparent optical element.

In another example embodiment, the optical system is configured to receive the heated gas flow through the flow channel prior to receiving the illumination from the laser source, and to receive the cooled gas flow after and during illumination by the laser source. In still another example embodiment, the transparent optical component comprises fused silica. In another example embodiment, the flow channel is a first flow channel, and the transparent optical element is a first transparent optical element, the optical system includes a second flow channel formed between a second surface of the optical component opposite to the first surface, and a second optical element, and one of the first or the second flow channels is configured to receive the heated gas flow and the other of the first or the second flow channels is configured to receive the cooled gas flow.

In yet another example embodiment, the optical system further includes a controller or a processor, configured to control operations of one or more of: the laser source, one or more gas flow controllers, one or more flow switches, a gas cooler or a gas heater. In another example embodiment, the optical system includes the laser source.

It is understood that the various disclosed embodiments may be implemented individually, or collectively, in devices comprised of various optical components, electronics hardware and/or software modules and components. These devices, for example, may comprise a processor, a memory unit, an interface that are communicatively connected to each other, and may range from desktop and/or laptop computers, to mobile devices and the like. The processor and/or controller can perform various disclosed operations based on execution of program code that is stored on a storage medium. The processor and/or controller can, for example, be in communication with at least one memory and with at least one communication unit that enables the exchange of data and information, directly or indirectly, through the communication link with other entities, devices and networks. The communication unit may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. For example, the processor may be configured to determine suitable flow rate values, heat source and/or thermal resistivities associated with target performance criteria for particular system geometries, composition of flow gases, and optical/thermal characteristics of system components.

The processing devices that are described in connection with the disclosed embodiments can be implemented as hardware, software, or combinations thereof. For example, a hardware implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

I/We claim:

1. A method for stabilizing a temperature of an optical component in an optical system, comprising:
preheating the optical component to a target temperature value by applying a heat source to the optical component, the optical component having an initial thermal resistance and heat sink temperature while being preheated;
turning on a laser source to illuminate the optical component; and
removing or reducing the heat source, while changing one or both the thermal resistance or the heat sink temperature from their initial values to lower values to maintain a temperature of the optical component at the target temperature value while the laser source is illuminating the optical component;
wherein:
a combination of an amount of heat applied to the optical component during preheating and one or both of the initial thermal resistance or heat sink temperature maintains the temperature of the optical component at the target temperature value, and
a combination of the lower thermal resistance value, heat sink temperature value, or heat delivered to the optical component by the laser source maintains the temperature of the optical component at the target temperature value after the laser source is turned on.

2. The method of claim 1, wherein the heat source is turned off simultaneously with turning on the laser, and changing the thermal resistance to a lower value includes cooling the optical component.

3. The method of claim 1, wherein pre-heating the optical component is performed by convective heating and changing the thermal resistance to the lower value is performed by convective cooling.

4. The method of claim 3, wherein pre-heating the optical component includes applying a heated gas flow to a surface of the optical component, and changing the thermal resistance to the lower value includes applying a cooled gas flow to the surface of the optical component.

5. The method of claim 4, wherein one or both of the heated gas flow or the cooled gas flow includes air, oxygen or helium.

6. The method of claim 1, wherein:
removing or reducing the heat source consists of removing the heat source that is done simultaneously with turning on the laser source, and
changing the thermal resistance to the lower value is done after a predetermined delay subsequent to turning on the laser source.

7. The method of claim 6, wherein the predetermined delay is determined to minimize temporal variations in the optical component's temperature.

8. The method of claim 1, wherein:
removing or reducing the heat source consists of removing the heat source that is done simultaneously with turning on the laser source, and
changing the thermal resistance to the lower value is initiated simultaneously with turning on the laser source by turning on a cooled air gas flow across a surface of the optical component.

9. The method of claim 1, wherein:
removing or reducing the heat source consists of removing the heat source that is done simultaneously with turning on the laser source, and
changing the thermal resistance to the lower value is initiated simultaneously with turning on the laser source by continuously increasing a cooled air gas flow across a surface of the optical component before continuously decreasing the cooled air gas flow across the surface of the optical component.

10. The method of claim 1, wherein a heat load associated with preheating the optical component is determined based at least on an absorption value of the optical component, and a power of the laser source illumination.

11. The method of claim 10, wherein the heat load associated with preheating the optical component is determined based additionally on a thermal sink temperature before turning on the laser and at steady-state.

12. The method of claim 1, further comprising increasing the thermal resistance value and heat applied to the optical component accompanied by a reduction in a laser beam that illuminates the optical component to maintain the temperature of the optical component at the target temperature.

13. An optical system with improved temperature stability, comprising:
an optical component configured to receive illumination from a laser source, the optical component having a particular absorption coefficient at an operating wavelength of the laser source; and
a flow channel formed between a first surface of the optical component and a transparent optical element, wherein the transparent optical element has substantially no absorption in the operating wavelength of the laser source,
wherein the flow channel is configured to receive a heated gas flow or a cooled gas flow therein for heating or cooling the optical component, respectively.

14. The optical system of claim 13, comprising one or more flow controllers, a gas cooler, a gas heater and one or more flow switches to receive one or more gases for producing the heated gas flow or the cooled gas flow.

15. The optical system of claim 13, wherein the optical component is configured to operate in transmission, with the illumination entering through a second surface of the optical component opposite to the first surface and exiting the first surface.

16. The optical system of claim 13, wherein the optical component is configured to operate in reflection, with the illumination reaching the first surface after passing through the transparent optical element and the flow channel, and reflecting from the optical component before passing again through the flow channel and the transparent optical element.

17. The optical system of claim 13, configured to receive the heated gas flow through the flow channel prior to receiving the illumination from the laser source, and to receive the cooled gas flow after and during illumination by the laser source.

18. The optical system of claim 13, wherein the transparent optical component comprises fused silica.

19. The optical system of claim 13, wherein:
the flow channel is a first flow channel, and the transparent optical element is a first transparent optical element, and
the optical system includes a second flow channel formed between a second surface of the optical component opposite to the first surface, and a second optical element, and
one of the first or the second flow channels is configured to receive the heated gas flow and the other of the first or the second flow channels is configured to receive the cooled gas flow.

20. The optical system of claim 13, further comprising a controller or a processor, configured to control operations of one or more of: the laser source, one or more gas flow controllers, one or more flow switches, a gas cooler or a gas heater.

21. The optical system of claim 13, comprising the laser source.
